(19) United States
(12) Patent Application Publication
(10) Pub. No.: US 2026/0146937 A1
(43) Pub. Date: May 28, 2026

(54) FILTER MONITORING APPARATUS FOR FILTER CLEANING

(71) Applicant: Saudi Electricity Company, Riyadh (SA)

(72) Inventors: Saleh Ali G. SHANNAN, Jeddah (SA); Murad Mebaireik A. ALMAZROUI, Jeddah (SA); Majed Mohammed M. ALSAQRI, Jeddah (SA)

(21) Appl. No.: 19/397,031

(22) Filed: Nov. 21, 2025

(30) Foreign Application Priority Data
Nov. 24, 2024 (SA) 1020247222

(51) Int. Cl. G01N 15/08; F24F 8/10; G08B 3/02

(52) U.S. Cl. CPC G01N 15/0806; F24F 8/10; G08B 3/02; G01N 2015/084; G01N 2015/0846

(57) ABSTRACT

The present disclosure provides a filter monitoring apparatus (herein also referred to as an alarm device) for alerting a user to clean filters (including split air conditioner filters and window air conditioner filters). The filter monitoring apparatus comprises an anterior module and a posterior module configured to be positioned on opposite sides of a filter, wherein the anterior module includes anterior magnets and the posterior module includes posterior magnets, the anterior magnets and posterior magnets configured to magnetically couple the anterior module and posterior module together with the filter positioned therebetween. A laser emitter disposed in the anterior module is configured to emit a laser beam through the filter toward the posterior module. A photodetector disposed in the posterior module is positioned to receive the laser beam from the laser emitter when the filter is clean. An alarm circuit comprises an acoustic alarm device and an alert indicator. An electronic circuit operatively connected to the photodetector and the alarm circuit is configured to activate the alarm circuit when the photodetector does not receive the laser beam due to dust accumulation on the filter blocking the laser beam.

### FIELD OF INVENTION

The present disclosure relates to filter maintenance devices, and more particularly to a filter monitoring apparatus that uses laser light and photodetector detection to alert users when filters, particularly air conditioner filters, require cleaning due to dust accumulation.

### BACKGROUND

Air conditioning systems have become ubiquitous in residential, commercial, and industrial settings, providing climate control and air quality management. These systems rely on filters to remove dust, debris, and airborne particles from the air before it is cooled and circulated throughout the interior space. Over time, these filters accumulate contaminants including dust and aeroplankton, which can reduce system efficiency and increase energy consumption without user knowledge.

Filter maintenance represents a common challenge for air conditioning system users. As filters become clogged with dust and other particles, airflow restriction increases, forcing the system to work harder to maintain desired temperature levels. Clogged AC filters reduce airflow and efficiency, straining the system and increasing energy consumption. This increased workload translates to higher electricity consumption and elevated operating costs, often causing electricity bills to rise without user awareness. Additionally, reduced airflow can compromise indoor air quality and place additional strain on system components.

Many users lack awareness of when their air conditioning filters require cleaning or replacement. Traditional maintenance approaches often rely on predetermined schedules or visual inspection, which may not accurately reflect actual filter condition. Scheduled maintenance may result in premature filter replacement or, conversely, allow filters to become excessively clogged before attention is given to them.

Various approaches have been developed to monitor air conditioning system performance and filter condition. For example, WO2023236561A1 discloses an invention for notifying and alerting users of air conditioners when filters are blocked by dust, depending on sensors that calculate the amount of air entering before the filter and the amount of air at the exit, calculating the difference between them. At a specific pre-programmed value, the user is alerted accordingly. However, many existing alerts rely on airflow measurements that can be skewed by fan condition or other variables, leading to inaccurate warnings. Such approaches may be influenced by factors beyond filter condition, including fan performance degradation due to impurity accumulation or poor performance from long use periods, and other mechanical variables that can affect airflow measurements, thereby creating the possibility of issuing inaccurate alerts or notices.

The complexity of installation and operation of monitoring systems can also present barriers to adoption. Systems that require specialized software, professional installation, or extensive technical knowledge may not be practical for many users. Additionally, monitoring approaches that depend on multiple sensors or complex calculations may introduce potential points of failure or inaccuracy.

There remains a need for straightforward, reliable methods to alert users when air conditioning filters require attention, particularly approaches that can provide direct indication of filter condition without being influenced by other system variables. Specifically, there is a need for a device that can protect air conditioners from filter blockage due to dust and aeroplankton accumulation, providing direct detection through optical means rather than indirect airflow calculations that may be affected by fan performance or other system variables.

### SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

According to an aspect of the present disclosure, a filter monitoring apparatus 18 and operation method for alerting a user to clean air conditioner filter is provided. The filter monitoring apparatus 18 comprises a housing made of a plastic material that can be manufactured in various shapes including cylindrical, square, triangle, rectangular, parallelogram, or spherical shape, wherein its shape is proportional to the type, area, and size of air conditioner filter. The filter monitoring apparatus 18 comprises two main parts located between them a selected filter portion 7, the anterior module 1 comprises anterior magnets 3, 4 configured to tightly adhere to the posterior magnets 12a, 12b on the posterior module 11, also comprises a wireless transmitter 17 to receive and send a Bluetooth or Wi-Fi signal via an application on the user phone to alert him. The anterior module 1 of the filter monitoring apparatus 18 comprises a laser emitter 2 installed at a particular angle so that its laser beam 13 penetrates the filter and ends by connecting to the photodetector 8 which is installed in the posterior module 11 of the filter monitoring apparatus 18.

According to another aspect of the present disclosure, an operation method of the filter monitoring apparatus 18 is provided. The method includes setting the photodetector 8 in the normal mode as follows: as long as the laser beam 13 from the laser emitter 2 is focused on the photodetector 8, the circuit will be opened, in other words, the electric current will not reach the alert indicator 5 and the acoustic alarm, and thus the device will continue to operate in the direct operation mode, which is the mode of operating the laser emitter 2, wherein it derives its electrical energy from a battery 10 or an electrical source coming from its respective air conditioner through the power connector 6 and power inlet 9. The method further includes setting the photodetector 8 in the emergency mode as follows: after the accumulation of dust on the selected filter portion 7, the laser beam 13 will be blocked from the photodetector 8, and the photodetector 8 will move to the shutdown position of the electrical circuit, and thus the electric current coming from the battery 10 or source will be allowed to pass through to operate the alert indicator 5 and acoustic alarm and the alarm will issue an alert through which the user will know that the filter needs urgent cleaning, and the wireless transmitter 17 will send Bluetooth or Wi-Fi signals to the user to alert him to clean the filter.

The foregoing general description of the illustrative embodiments and the following detailed description thereof are merely exemplary aspects of the teachings of this disclosure and are not restrictive.

### BRIEF DESCRIPTION OF FIGURES

Non-limiting and non-exhaustive examples are described with reference to the following figures.

FIG. 1 illustrates an exploded view of a filter monitoring apparatus 18 for monitoring air conditioner filter cleanliness. The alarm device comprises two main parts: an anterior module 1 and a posterior module 11, which are configured to be positioned on opposite sides of a selected filter portion 7. The anterior module 1 includes a laser emitter 2 positioned at the top, anterior magnets 3, 4, an alert indicator 5, and a wireless transmitter 17. The posterior module 11 includes corresponding posterior magnets 12a, 12b, a photodetector 8, a power inlet 9, and a battery 10. A power connector 6 provides an alternative power connection from an air conditioner.

FIG. 2 illustrates a side view of the filter monitoring apparatus 18 in an assembled configuration. The apparatus comprises an anterior module 1 and a posterior module 11 positioned on opposite sides of a filter. The laser beam 13 is shown as a dashed line extending from the laser emitter 2 through the filter and terminating at the photodetector 8. The magnetic coupling between anterior magnets 3, 4 and posterior magnets 12a, 12b secures the two modules together. An electric feed socket 14 is shown at the bottom with a power connector 6, and a wireless transmitter 17 is positioned at the top of the anterior module.

FIG. 3 illustrates a view of an AC unit filter 15 with a filter monitoring apparatus 18 installed at a specific installation position 16 on the filter grid structure. The AC unit filter 15 is depicted as a rectangular mesh grid comprising multiple rows and columns of filter cells, with the filter monitoring apparatus 18 positioned in the third row from the top and second column from the left.

### DETAILED DESCRIPTION

The following description sets forth exemplary aspects of the present disclosure. It should be recognized, however, that such description is not intended as a limitation on the scope of the present disclosure. Rather, the description also encompasses combinations and modifications to those exemplary aspects described herein.

According to an aspect of the present disclosure, a filter monitoring apparatus 18 (herein also referred to as an alarm device) and operation method for alerting a user to clean air conditioner filter is provided.

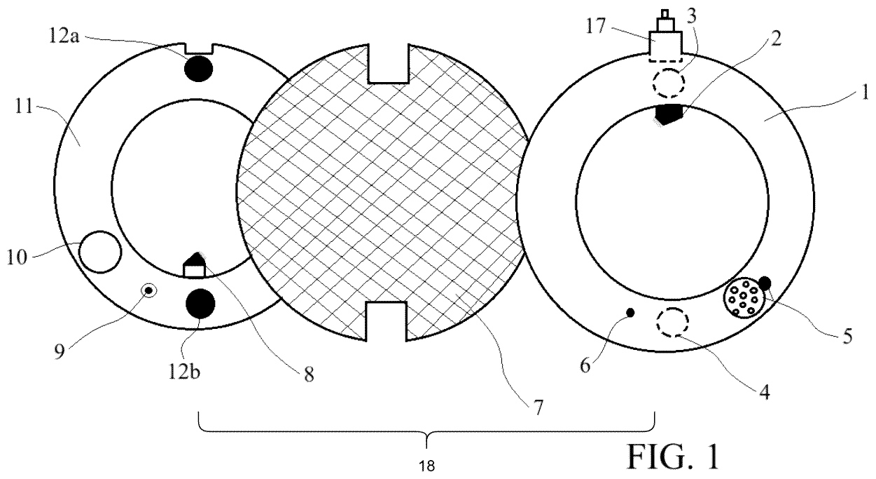

Referring to FIG. 1, the filter monitoring apparatus 18 may comprise a two-part device including an anterior module 1 and a posterior module 11 configured to be positioned on opposite sides of a selected filter portion 7. The filter monitoring apparatus 18 may have a housing made of plastic material that can be manufactured in various geometric configurations. In some cases, the housing may have a cylindrical shape, or alternatively, the housing may have a shape selected from the group consisting of square, triangle, rectangular, parallelogram, and spherical shape. The dimensions of the housing may be proportional to the type, area, and size of the air conditioner filter to ensure proper fit and functionality, particularly for split air conditioner filters and window air conditioner filters.

The anterior module 1 may include several components configured to detect filter blockage conditions (e.g. caused by dust and aeroplankton accumulation). A laser emitter 2 may be disposed in the anterior module 1 and installed at a particular angle to ensure proper penetration through the air conditioner filter toward the posterior module 11. The laser emitter 2 may be positioned at an upper portion of the anterior module 1 to direct laser lighting through the selected filter portion 7.

As further shown in FIG. 1, the anterior module 1 may include anterior magnets 3 and anterior magnets 4 configured for magnetic coupling with corresponding components in the posterior module 11. In preferred embodiments, the anterior magnets may comprise an upper magnet and a lower magnet disposed at the top and bottom of the anterior module 1, where anterior magnets 3 may function as the upper magnet and anterior magnets 4 may function as the lower magnet. The anterior magnets 3 and anterior magnets 4 may be positioned to create tight adhesion with posterior magnets in the posterior module 11 through gravity forces generated by the magnetic attraction, enabling the modules to connect securely on each side of the filter.

The anterior module 1 may further include an alert indicator 5 configured to provide visual warnings to the user when filter cleaning is needed (for example, due to dust and aeroplankton accumulation). The alert indicator 5 may be positioned within the anterior module 1 and may be operatively connected to an alarm circuit that activates when dust accumulation blocks laser transmission through the selected filter portion 7.

With continued reference to FIG. 1, a wireless transmitter 17 may be disposed in the anterior module 1 and configured to send alert signals to a user device. The wireless transmitter 17 may function through a regulator that receives and sends Bluetooth or Wi-Fi signals via an application on the user's phone. In some cases, the wireless transmitter 17 may be configured to communicate via Bluetooth or Wi-Fi signals to inform the user of filter status and cleaning requirements. The wireless transmitter 17 may be positioned at an upper portion of the anterior module 1 to facilitate wireless communication with external devices.

The posterior module 11 may be configured to house several components that work in conjunction with the anterior module 1 to provide filter monitoring functionality for both split air conditioner filters and window air conditioner filters. As shown in FIG. 1, the posterior module 11 may be positioned opposite to the anterior module 1 with the selected filter portion 7 positioned between the two modules.

A photodetector 8 may be disposed in the posterior module 11 and positioned to receive the laser beam from the laser emitter 2 when the air conditioner filter is clean. The photodetector 8 may function as a photocell switch that operates in different modes based on laser beam reception, including connection mode and shutdown mode. In some cases, the photodetector 8 may be positioned to align with the laser emitter 2 to ensure proper detection of laser lighting transmitted through the selected filter portion 7.

With continued reference to FIG. 1, the posterior module 11 may include posterior magnets 12a and posterior magnets 12b configured to magnetically couple with the anterior magnets 3 and anterior magnets 4 of the anterior module 1. In preferred embodiments, the posterior magnets 12a and posterior magnets 12b may be positioned at the top and bottom of the posterior module 11, where posterior magnets 12a may align with anterior magnets 3 and posterior magnets 12b may align with anterior magnets 4. The posterior magnets may comprise an upper magnet and a lower magnet disposed in the posterior module 11. The anterior magnets and posterior magnets may be configured to magnetically couple the anterior module 1 and posterior module 11 together with the air conditioner filter positioned therebetween, creating a secure attachment through gravity forces generated by magnetic attraction. The apparatus can be easily separated by removing the modules by releasing them from gravity forces due to the magnets and then easily reinserted via the magnetic coupling.

The filter monitoring apparatus 18 may further comprise a power source operatively connected to an electronic circuit. As further shown in FIG. 1, a battery 10 may be disposed within the posterior module 11 to provide electrical energy to the filter monitoring apparatus 18. In some cases, the battery 10 may be a disk battery that supplies power to operate the laser emitter 2, photodetector 8, alert indicator 5, and wireless transmitter 17.

A power inlet 9 may be configured within the posterior module 11 as a female inlet to receive electrical connections from external power sources. The power inlet 9 may be positioned to accept power connections that provide an alternative to battery power operation. In some cases, a power connector 6 may function as a male electrical source from the air conditioner that connects to the power inlet 9. The power connector 6 may comprise a power source that receives power from the air conditioner through the power inlet 9, allowing the filter monitoring apparatus 18 to derive electrical energy directly from the air conditioner system rather than relying solely on the battery 10. In preferred embodiments, the power supply configuration may utilize a male electrical source (power connector 6) that interfaces with a female inlet (power inlet 9) to establish secure electrical connections between the monitoring apparatus and the air conditioning system.

Referring to FIG. 1, an alarm circuit may be operatively connected to the filter monitoring apparatus 18 to provide user notifications when filter cleaning is required due to dust and aeroplankton accumulation. The alarm circuit may comprise an acoustic alarm device and/or the alert indicator 5. In some cases, the acoustic alarm device may function as an acoustic bell that generates audible warnings to alert users of filter blockage conditions. The alert indicator 5 may provide visual warnings through optical signals, creating a dual notification system that combines both audible and visual alerts.

An electronic circuit may be operatively connected to the photodetector 8 and the alarm circuit to control the operational states of the filter monitoring apparatus 18. The electronic circuit may be configured to manage power distribution and signal processing based on laser beam detection status, operating in connection mode and shutdown mode. In some cases, the electronic circuit may receive input signals from the photodetector 8 and process these signals to determine appropriate alarm activation responses. The electronic circuit is configured to activate the alarm circuit when the photodetector 8 does not receive the laser beam.

The electronic circuit may operate in two distinct modes based on the reception status of laser lighting from the laser emitter 2. During normal operation mode, the electronic circuit may maintain a connection mode configuration when the photodetector 8 receives the laser beam transmitted through the selected filter portion 7. In this connection mode operating state, the circuit may be opened to disconnect electric current from the acoustic alarm device and the alert indicator 5, preventing activation of warning signals while the filter remains clean and unobstructed.

As further shown in FIG. 1, the electronic circuit may transition to shutdown mode when dust and aeroplankton accumulation on the selected filter portion 7 blocks the laser beam from reaching the photodetector 8. During shutdown mode operation, the electronic circuit may close the circuit to allow current passage from the battery 10 or power connector 6 to flow through to the acoustic alarm device and the alert indicator 5. The electronic circuit may be configured to activate the alarm circuit when the photodetector 8 does not receive the laser beam due to dust and aeroplankton accumulation on the air conditioner filter blocking the laser beam.

In some cases, the electronic circuit may function as a control circuit that activates an alarm system and the wireless transmitter 17 when the photodetector 8 indicates that the laser beam is blocked by dust and aeroplankton accumulation on the air conditioner filter. The alarm system may comprise at least one of an acoustic alarm and the alert indicator 5, providing multiple notification methods to ensure user awareness of filter cleaning requirements. When activated, the control circuit may simultaneously trigger the acoustic alarm device, the alert indicator 5, and the wireless transmitter 17 to provide comprehensive user notification through audible, visual, and wireless communication channels, resulting in immediate electricity bill reduction benefits through timely filter maintenance.

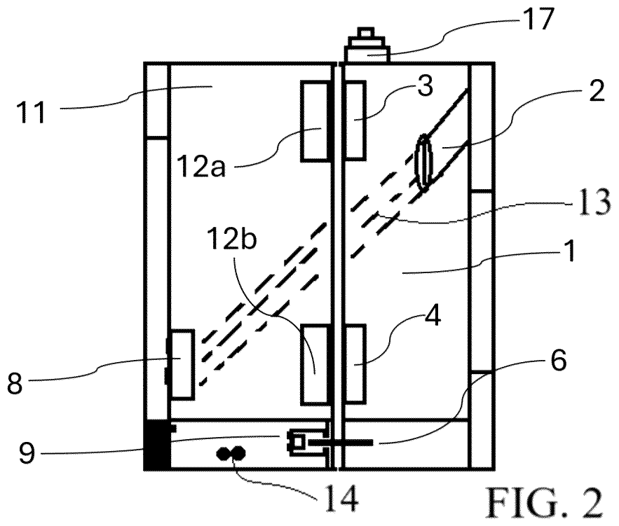

Referring to FIG. 2, the filter monitoring apparatus 18 may be shown in an assembled configuration that demonstrates the operational arrangement of the two-part housing. The assembled configuration may illustrate how the anterior module 1 and the posterior module 11 are positioned on opposite sides of a filter and magnetically coupled together through gravity forces to form a functional monitoring system for both split air conditioner filters and window air conditioner filters. In some cases, the two-part housing may be configured to be installed on an air conditioner filter, with the housing comprising the anterior module 1 and the posterior module 11 that magnetically attach to each other with the air conditioner filter positioned between them.

The magnetic coupling mechanism may be clearly visible in the assembled configuration, where the anterior module 1 may comprise anterior magnets 3 and anterior magnets 4, and the posterior module 11 may comprise posterior magnets 12a and posterior magnets 12b configured to magnetically couple with the anterior magnets through gravity forces. The magnetic coupling between the anterior magnets 3 and anterior magnets 4 of the anterior module 1 and the posterior magnets 12a and posterior magnets 12b of the posterior module 11 may secure the two modules together with the filter positioned between them, while allowing easy separation by releasing the gravity forces due to the magnets and easy reinsertion via the magnetic coupling.

As further shown in FIG. 2, the laser emitter 2 may be positioned in the anterior module 1 and oriented to direct a laser beam 13 through the air conditioner filter toward the posterior module 11. The laser beam 13 may be illustrated as a dashed line extending from the laser emitter 2 through the filter material and terminating at the photodetector 8 located in the posterior module 11. In some cases, the laser beam 13 may pass through the filter material when the filter is unobstructed, allowing the photodetector 8 to detect the laser beam 13 when the air conditioner filter is clean and free from dust and aeroplankton accumulation.

With continued reference to FIG. 2, the photodetector 8 may be positioned in the posterior module 11 to detect the laser beam 13 when the air conditioner filter is unobstructed by dust and aeroplankton accumulation. The photodetector 8 may be strategically positioned to receive the laser beam 13 from the laser emitter 2, creating an optical detection system that monitors filter cleanliness through laser transmission analysis and operates in connection mode and shutdown mode based on detection status.

The assembled configuration may further demonstrate the power supply connections available for the filter monitoring apparatus 18. As shown in FIG. 2, an electric feed socket 14 may be positioned at the bottom of the apparatus, providing a connection point for power supply. The electric feed socket 14 may serve as a power distribution hub that facilitates electrical connections between external power sources and the filter monitoring apparatus 18. In some cases, the power connector 6 may extend from the electric feed socket 14, enabling the apparatus to receive power from an external source such as an air conditioner through a male electrical source and female inlet configuration.

The power inlet 9 may be configured within the posterior module 11 to receive electrical power through the electric feed socket 14 and the power connector 6. The power supply arrangement may allow the filter monitoring apparatus 18 to operate using power derived directly from the air conditioner system, providing an alternative to battery-powered operation and ensuring continuous monitoring capability with immediate electricity bill reduction benefits through optimal filter maintenance.

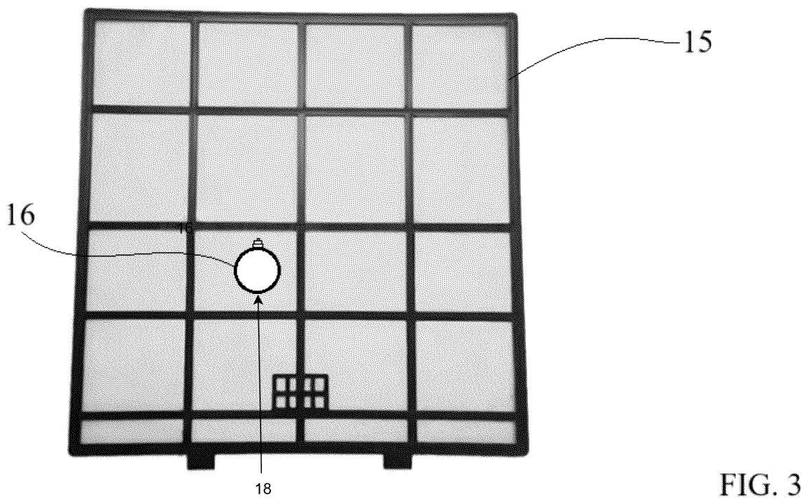

Referring to FIG. 3, an AC unit filter 15 may be depicted as a rectangular mesh grid comprising multiple rows and columns of filter cells arranged in a uniform pattern. The AC unit filter 15 may provide a structured surface that facilitates strategic placement of monitoring equipment at locations where dust and aeroplankton accumulation typically occurs. In some cases, the rectangular mesh grid may offer multiple potential mounting locations that allow users to select optimal positioning based on observed contamination patterns for both split air conditioner filters and window air conditioner filters.

An installation position 16 may be located within the grid structure of the AC unit filter 15, where the installation position 16 represents a specific location selected for mounting monitoring equipment. As shown in FIG. 3, the installation position 16 may be positioned in the third row from the top and second column from the left of the filter grid, demonstrating how users can target specific areas of the AC unit filter 15 for monitoring purposes. The installation position 16 may be strategically selected by the user based on locations where dust and aeroplankton typically accumulate from previous filter cleanings, enabling early detection of blockage conditions before complete filter obstruction occurs.

With continued reference to FIG. 3, a filter monitoring apparatus 18 may be mounted at the installation position 16 on the surface of the AC unit filter 15. The filter monitoring apparatus 18 may be shown as a circular device that integrates with the mesh structure of the AC unit filter 15 to provide localized monitoring of filter cleanliness for both split air conditioner filters and window air conditioner filters. In some cases, positioning a filter monitoring apparatus on an air conditioner filter may involve securing the device at predetermined locations where dust and aeroplankton contamination typically develops during normal air conditioning operation.

The filter monitoring apparatus 18 may be secured to the AC unit filter 15 at the installation position 16 through magnetic coupling between the anterior module and posterior module positioned on opposite sides of the filter mesh using gravity forces generated by magnetic attraction. The magnetic attachment mechanism may allow the filter monitoring apparatus 18 to maintain stable positioning while permitting easy removal by releasing the gravity forces due to the magnets and easy reinsertion via the magnetic coupling for filter cleaning and maintenance procedures. In some cases, the filter monitoring apparatus 18 may have an anterior module with a laser emitter and a posterior module with a photodetector, wherein the anterior module and posterior module are magnetically coupled on opposite sides of the air conditioner filter through gravity forces.

As further shown in FIG. 3, the grid structure of the AC unit filter 15 may provide multiple potential mounting locations that enable users to customize installation based on specific air conditioning system characteristics and observed dust and aeroplankton accumulation patterns. The installation position 16 may be selected to target areas where dust and aeroplankton typically concentrate during air filtration processes, allowing the filter monitoring apparatus 18 to detect blockage conditions before contamination spreads throughout the entire AC unit filter 15.

The filter monitoring apparatus 18 may be designed to protect air conditioners from both dust and aeroplankton accumulation that causes air conditioning efficiency decrease and electricity bill increases. In some cases, aeroplankton particles may combine with dust particles to create filter blockages that reduce airflow and force air conditioning systems to consume additional electrical energy to maintain desired cooling performance. The strategic positioning of the filter monitoring apparatus 18 at the installation position 16 may enable early detection of contamination buildup, allowing users to perform preventive maintenance before system efficiency degradation occurs, resulting in immediate electricity bill reduction benefits.

The installation configuration may allow users to monitor specific sections of the AC unit filter 15 rather than waiting for complete filter blockage to develop. By targeting the installation position 16 where contamination typically accumulates first, the filter monitoring apparatus 18 may provide advance warning that enables timely filter cleaning and maintenance, thereby maintaining optimal air conditioning performance and preventing unnecessary increases in electricity consumption with immediate electricity bill reduction benefits.

With continued reference to FIG. 2, a method for alerting a user to clean an air conditioner filter may involve operating the filter monitoring apparatus 18 in a normal operation mode that maintains continuous monitoring while preventing false alarm activation. The normal operation mode may be established when the filter monitoring apparatus 18 is properly positioned on an air conditioner filter with the anterior module 1 and posterior module 11 magnetically coupled on opposite sides of the filter material through gravity forces generated by magnetic attraction.

During normal operation mode, the method may comprise emitting a laser beam 13 from the laser emitter 2 through the air conditioner filter toward the photodetector 8. As shown in FIG. 2, the laser beam 13 may be transmitted from the laser emitter 2 positioned in the anterior module 1 and directed through the filter material to reach the photodetector 8 located in the posterior module 11. The laser beam 13 may pass unobstructed through clean filter material, allowing continuous optical communication between the laser emitter 2 and the photodetector 8.

The method may further comprise maintaining an alarm circuit in an inactive state when the photodetector 8 receives the laser beam 13, operating in connection mode. In some cases, the photodetector 8 may function as a photocell switch that maintains a connection mode configuration when receiving laser illumination from the laser emitter 2. During this normal operating condition, the electronic circuit may prevent electric current from reaching the acoustic alarm device and the alert indicator 5, thereby keeping the alarm system in a dormant state while the filter remains clean and functional.

The normal operation mode may be sustained through continuous laser beam transmission that creates a closed optical loop between the laser emitter 2 and the photodetector 8. When the laser beam 13 successfully reaches the photodetector 8, the electronic circuit may interpret this signal as an indication that the filter material remains unobstructed by dust accumulation or aeroplankton contamination. The photodetector 8 may maintain the alarm circuit in an inactive state by preventing current flow to alarm components, ensuring that users are not disturbed by unnecessary notifications while the filter operates within acceptable cleanliness parameters.

The method may further comprise powering the filter monitoring apparatus 18 using multiple power supply options during normal operation mode. In some cases, the method may include a step of powering the filter monitoring apparatus 18 using a battery 10, which may be a disk battery that provides electrical energy to operate the laser emitter 2, photodetector 8, and associated electronic circuits. The battery-powered operation may enable the filter monitoring apparatus 18 to function independently of external power connections, providing flexibility in installation locations and ensuring continuous monitoring capability even during air conditioner maintenance procedures.

Alternatively, the method may comprise a step of powering the filter monitoring apparatus 18 using a power connector 6 functioning as a male electrical source to receive power from the air conditioner through a power inlet 9 functioning as a female inlet. As further shown in FIG. 2, the power connector 6 may extend from the electric feed socket 14 to establish electrical connection with the air conditioner system, allowing the filter monitoring apparatus 18 to derive operating power directly from the air conditioning unit. This power supply configuration may eliminate the need for battery replacement and ensure continuous operation as long as the air conditioner remains connected to electrical power.

During normal operation mode, the power supply system may maintain consistent electrical energy delivery to all components of the filter monitoring apparatus 18, including the laser emitter 2 that generates the laser beam 13 and the photodetector 8 that receives and processes optical signals. The electronic circuit may manage power distribution to ensure that the laser emitter 2 operates at appropriate intensity levels for reliable detection while the photodetector 8 maintains sensitivity to distinguish between blocked and unblocked laser transmission conditions.

With continued reference to FIG. 2, the filter monitoring apparatus 18 may transition from normal operation mode to emergency operation mode when dust and aeroplankton accumulation on the air conditioner filter blocks the laser beam 13 from reaching the photodetector 8. During emergency mode operation, the continuous optical communication between the laser emitter 2 and the photodetector 8 may be interrupted due to dust and aeroplankton particles that accumulate on the filter material and obstruct the transmission path of the laser beam 13.

The transition to emergency mode may occur when the photodetector 8 no longer receives the laser beam 13 due to dust and aeroplankton accumulation creating an optical barrier between the laser emitter 2 and the photodetector 8. In some cases, the accumulated dust and aeroplankton impurities may form a layer on the filter material that prevents the laser beam 13 from penetrating through the filter and reaching the photodetector 8 in the posterior module 11. When the laser beam 13 is blocked, the photodetector 8 may transition from a connection mode to shutdown mode (i.e. an open circuit state to a closed circuit state), signaling the electronic circuit to initiate emergency response procedures.

The electronic circuit may be configured to detect the absence of laser beam reception at the photodetector 8 and respond by activating an alarm circuit to generate acoustic and optical alarms. When dust accumulation blocks the laser beam 13, the electronic circuit may close the circuit to allow electric current from the battery 10 or power connector 6 to flow through to the acoustic alarm device and the alert indicator 5. In some cases, the alarm circuit may comprise both an acoustic alarm device that generates audible warnings and the alert indicator 5 that provides visual notifications to alert users of filter blockage conditions.

The method for alerting a user to clean an air conditioner filter may comprise activating the alarm circuit to generate an acoustic alarm and an alert indicator when dust accumulation on the air conditioner filter blocks the laser beam from reaching the photodetector. The acoustic alarm may function as an acoustic bell that produces audible signals to notify users that the filter requires immediate attention. Simultaneously, the alert indicator 5 may generate optical warnings through visual signals, creating a dual notification system that ensures user awareness through both audible and visual alert mechanisms, providing immediate electricity bill reduction benefits through timely maintenance.

As further shown in FIG. 2, the wireless transmitter 17 may be activated during emergency mode operation to provide additional notification capabilities beyond the local acoustic and optical alarms. The wireless transmitter 17 may be configured to send alert signals to a user device when the alarm circuit is activated, enabling remote notification of filter cleaning requirements. In some cases, the method may further comprise a step of sending wireless alert signals to a user device using the wireless transmitter 17 when the alarm circuit is activated.

The wireless alert functionality may enable the filter monitoring apparatus 18 to communicate filter status information to users who may not be in immediate proximity to the air conditioning system. The wireless transmitter 17 may establish communication with user devices through wireless protocols that facilitate real-time monitoring and enable users to track filter cleanliness over time. In some cases, the method may include wireless alert signals that are transmitted via Bluetooth or Wi-Fi signals to ensure compatibility with various user devices and communication networks.

Referring to FIG. 3, the emergency mode operation may be particularly effective when the filter monitoring apparatus 18 is positioned at the installation position 16 where dust typically accumulates during normal air conditioning operation. The strategic placement at the installation position 16 may enable early detection of contamination buildup, allowing the filter monitoring apparatus 18 to activate emergency mode before dust accumulation spreads throughout the entire AC unit filter 15. The installation position 16 may be selected based on observed dust and aeroplankton accumulation patterns from previous filter cleanings, ensuring that the filter monitoring apparatus 18 detects blockage conditions at locations where contamination typically develops first.

The wireless transmitter 17 may function through a regulator that processes and transmits immediate Bluetooth or Wi-Fi signals to user devices through dedicated applications. When emergency mode is activated, the wireless transmitter 17 may immediately send alert signals to inform users that the filter requires urgent cleaning. The wireless communication may provide detailed information about filter status and cleaning requirements, enabling users to respond promptly to maintain optimal air conditioning performance and prevent system efficiency degradation with electricity bill reduction benefits.

During emergency mode operation, the filter monitoring apparatus 18 may continue to generate acoustic alarms, optical warnings, and wireless notifications until the filter cleaning process is completed and normal laser beam transmission is restored. The sustained alert system may ensure that users receive continuous notification of filter blockage conditions, preventing prolonged operation with obstructed filters that can cause air conditioning efficiency decrease and electricity bill increases. The emergency mode may remain active until dust accumulation is removed from the filter material and the laser beam 13 can once again reach the photodetector 8 to restore normal operation mode.

Referring to FIG. 1, an air conditioner filter monitoring system may comprise multiple interconnected components that function together to provide comprehensive filter monitoring and user notification capabilities for both split air conditioner filters and window air conditioner filters. The air conditioner filter monitoring system may integrate optical detection, magnetic coupling through gravity forces, power management, and wireless communication technologies to create a unified monitoring solution that operates independently of air conditioning system variables such as fan performance or airflow measurements.

The integrated system may function through coordinated interaction between the anterior module and posterior module components, where each element contributes to the overall monitoring and notification process. As shown in FIG. 1, the laser emitter and photodetector may establish an optical detection loop that serves as the primary sensing mechanism for the air conditioner filter monitoring system. The optical detection method may provide direct measurement of filter obstruction without relying on airflow calculations or fan performance assessments that can be affected by system wear or maintenance conditions.

With continued reference to FIG. 1, a control circuit may be operatively connected to multiple system components to coordinate detection, processing, and notification functions. The control circuit may receive input signals from the photodetector and process these signals to determine appropriate system responses based on laser beam reception status, operating in connection mode and shutdown mode. In some cases, the control circuit may manage the operational states of both local alarm components and wireless communication systems to ensure comprehensive user notification when filter cleaning is required.

The control circuit may be configured to activate both an alarm system and a wireless transmitter when the photodetector indicates that laser beam transmission is blocked by dust accumulation on the air conditioner filter. The coordinated activation may ensure that users receive multiple forms of notification through acoustic alarms, visual indicators, and wireless communications to user devices. The control circuit may simultaneously trigger all notification systems to maximize the likelihood that users will receive and respond to filter cleaning alerts, providing electricity bill reduction benefits through timely maintenance.

As further shown in FIG. 1, the air conditioner filter monitoring system may further comprise a power source operatively connected to the control circuit to provide electrical energy for all system components. The power source may comprise at least one of a battery (which may be a disk battery) and a power connector configured as a male electrical source to receive power from an air conditioner through a power inlet functioning as a female inlet. The dual power supply configuration may provide operational flexibility and ensure continuous monitoring capability under various installation conditions and user preferences.

The battery may function as a primary power source that enables independent operation of the air conditioner filter monitoring system without requiring electrical connections to the air conditioning unit. In some cases, the battery may provide sufficient electrical energy to operate the laser emitter, photodetector, control circuit, alarm system, and wireless transmitter for extended periods, allowing the system to function during air conditioner maintenance or power interruptions.

The power connector may provide an alternative power supply method that derives electrical energy directly from the air conditioner through the power inlet using a male electrical source and female inlet configuration. The power connector configuration may eliminate the need for battery replacement and ensure continuous system operation as long as the air conditioner remains connected to electrical power. The power inlet may be configured to receive electrical connections from the air conditioner, creating a direct power supply link that integrates the monitoring system with the air conditioning unit's electrical infrastructure.

Referring to FIG. 3, the complete operational cycle of the air conditioner filter monitoring system may begin with installation at a selected installation position on the AC unit filter. The installation process may involve positioning the anterior module and posterior module on opposite sides of the filter material at locations where dust accumulation typically occurs during normal air conditioning operation. The magnetic coupling mechanism through gravity forces may secure the system components in place while allowing easy removal by releasing the gravity forces due to the magnets and easy reinsertion via the magnetic coupling for filter cleaning and maintenance procedures.

During normal operation, the air conditioner filter monitoring system may continuously monitor filter cleanliness through laser beam transmission analysis. The laser emitter may generate optical signals that pass through the filter material and reach the photodetector when the filter remains unobstructed. The control circuit may interpret successful laser beam reception as an indication that the filter operates within acceptable cleanliness parameters, maintaining the alarm system and wireless transmitter in inactive states to prevent unnecessary user notifications.

As dust and aeroplankton particles accumulate on the filter material during air conditioning operation, the optical transmission path between the laser emitter and photodetector may gradually become obstructed. The direct detection method may provide immediate response to filter contamination without being affected by fan performance variations, airflow measurement errors, or other system variables that can influence indirect monitoring approaches. The optical detection system may respond specifically to dust accumulation at the monitored location, providing accurate assessment of filter cleanliness conditions.

With continued reference to FIG. 3, the strategic positioning of the air conditioner filter monitoring system at the installation position may enable early detection of contamination buildup before complete filter blockage occurs. The early warning capability may allow users to perform preventive maintenance that maintains optimal air conditioning efficiency and prevents increased energy consumption associated with obstructed filters. The system may detect localized dust accumulation and alert users to clean the entire filter before contamination spreads throughout the AC unit filter.

Referring to FIG. 2, when dust accumulation blocks the laser beam transmission, the control circuit may initiate a comprehensive notification sequence that activates multiple alert mechanisms simultaneously. The integrated response may include acoustic alarms for immediate local notification, visual indicators for users in proximity to the air conditioning system, and wireless communications for remote user notification. The coordinated activation may ensure that users receive filter cleaning alerts regardless of their location relative to the air conditioning system.

The wireless transmitter may be configured to send alert signals to a user device when the control circuit detects filter blockage conditions. The wireless communication capability may extend the notification range beyond the immediate vicinity of the air conditioning system, enabling users to receive filter cleaning alerts while away from the monitored location. In some cases, the wireless transmitter may be configured to communicate with the user device via Bluetooth or Wi-Fi signals to ensure compatibility with various user devices and communication networks.

The wireless communication functionality may provide detailed information about filter status and cleaning requirements through dedicated applications on user devices. The wireless transmitter may establish communication protocols that facilitate real-time monitoring and enable users to track filter cleanliness over time. The wireless alert signals may include specific information about the monitored location and recommended cleaning procedures to help users maintain optimal air conditioning performance.

As further shown in FIG. 2, the complete operational cycle may continue until users respond to the notification alerts by removing the air conditioner filter monitoring system and cleaning the filter material. The magnetic coupling mechanism may allow easy separation of the anterior module and posterior module by releasing the gravity forces due to the magnets to facilitate filter removal and cleaning procedures. After filter cleaning is completed, the system may be easily reinserted via the magnetic coupling at the same installation position to resume monitoring operations.

The restoration of clean filter conditions may allow laser beam transmission to resume between the laser emitter and photodetector, signaling the control circuit to deactivate the alarm system and wireless transmitter. The system may automatically return to normal operation mode when optical communication is restored, demonstrating the self-regulating capability of the integrated monitoring system. The complete operational cycle may repeat continuously to provide ongoing filter monitoring and user notification throughout the operational life of the air conditioning system.

The air conditioner filter monitoring system may provide substantial benefits for maintaining air conditioning efficiency and preventing increased energy consumption through early detection and user notification capabilities. The direct detection method may eliminate false alarms caused by fan performance variations or airflow measurement errors, providing reliable filter cleanliness assessment that enables timely maintenance responses. The integrated system approach may ensure comprehensive user notification through multiple communication channels, maximizing the likelihood that users will receive and respond to filter cleaning requirements before complete blockage occurs.

According to an aspect of the present disclosure, an alarm device and operation method for alerting a user to clean air conditioner filter may be provided as shown in FIG. 1. The alarm device may comprise a housing made of plastic material that can be manufactured in a cylindrical shape or other geometric configurations. In some cases, the housing may be manufactured from shapes including square, triangle, rectangular, parallelogram, or spherical configurations, where the shape may be proportional to the type, area, and size of the air conditioner filter to ensure proper compatibility and functionality.

The alarm device may comprise two main parts positioned with a mesh filter 7 located between them. The anterior part 1 may comprise an upper magnet 3 and a lower magnet 4 configured to tightly adhere to corresponding magnets 12a and 12b on the posterior part 11. The anterior part may also comprise a regulator configured to receive and send Bluetooth or Wi-Fi signals via an application on the user's phone to provide alert notifications. The anterior part of the alarm device may comprise laser lighting 2 installed at a particular angle so that its light 13 penetrates the filter 7 and connects to a light cell switch 8 which may be installed in the posterior part of the alarm device.

An operation method of the alarm device may involve setting the photocell switch in normal mode operation. During normal mode, as long as the laser lighting remains focused on the switch, the circuit may be opened, preventing electric current from reaching the acoustic bell and warning light 5. In this configuration, the device may continue to operate in direct operation mode, which represents the standard operating mode of the laser lighting. The laser lighting may derive its electrical energy from a disk battery 10 or an electrical source coming from the respective air conditioner.

The operation method may further involve setting the photocell switch in emergency mode when filter contamination occurs. After dust accumulation on the device filter, the light may be blocked from the photocell switch, causing the switch to move to the shutdown position of the electrical circuit. In this emergency configuration, electric current from the battery or source may be allowed to pass through to operate the acoustic alarm device and warning light 5. The alarm may issue an alert through which the user may know that the filter needs urgent cleaning. Additionally, the regulator may send 17 Bluetooth or Wi-Fi signals to the user to alert them to clean the filter, providing comprehensive notification through multiple communication channels.

A number of implementations have been described. Nevertheless, it will be understood that various modifications may be made without departing from the spirit and scope of the disclosure. Accordingly, other implementations are within the scope of the following claims.

1. A filter monitoring apparatus for alerting a user to clean a filter, comprising:
an anterior module and a posterior module configured to be positioned on opposite sides of a filter, wherein the anterior module includes anterior magnets and the posterior module includes posterior magnets, the anterior magnets and posterior magnets configured to magnetically couple the anterior module and posterior module together with the filter positioned therebetween;
a laser emitter disposed in the anterior module and configured to emit a laser beam through the filter toward the posterior module;
a photodetector disposed in the posterior module and positioned to receive the laser beam from the laser emitter;
an alarm circuit comprising an acoustic alarm device and/or an alert indicator; and
an electronic circuit operatively connected to the photodetector and the alarm circuit, wherein the electronic circuit is configured to activate the alarm circuit when the photodetector does not receive the laser beam.

2. The filter monitoring apparatus of claim 1, wherein the anterior magnets comprise an upper magnet and a lower magnet disposed in the anterior module and/or wherein the posterior magnets comprise an upper magnet and a lower magnet disposed in the posterior module.

3. The filter monitoring apparatus of claim 1, wherein the filter is an air conditioner filter.

4. The filter monitoring apparatus of claim 1, wherein the housing has a cylindrical shape.

5. The filter monitoring apparatus of claim 1, wherein the housing has a shape selected from the group consisting of square, triangle, rectangular, parallelogram, and spherical shape.

6. The filter monitoring apparatus of claim 1, further comprising a power source operatively connected to the electronic circuit.

7. The filter monitoring apparatus of claim 6, wherein the power source comprises a battery.

8. The filter monitoring apparatus of claim 3, wherein the power source comprises a power connector configured to receive power from the air conditioner through a power inlet.

9. The filter monitoring apparatus of claim 1, further comprising a wireless transmitter configured to send alert signals to a user device.

10. The filter monitoring apparatus of claim 9, wherein the wireless transmitter is configured to communicate via Bluetooth or Wi-Fi signals.

11. A method for alerting a user to clean a filter, comprising:
positioning a filter monitoring apparatus on a filter, the filter monitoring apparatus having an anterior module with a laser emitter and a posterior module with a photodetector, wherein the anterior module and posterior module are magnetically coupled on opposite sides of the filter;
emitting a laser beam from the laser emitter through the filter toward the photodetector;
maintaining an alarm circuit in an inactive state when the photodetector receives the laser beam; and
activating the alarm circuit to generate an acoustic alarm and an alert indicator when dust accumulation on the filter blocks the laser beam from reaching the photodetector.

12. The method of claim 11, wherein the filter is an air conditioner filter.

13. The method of claim 11, further comprising a step of powering the filter monitoring apparatus using a battery.

14. The method of claim 12, further comprising a step of powering the filter monitoring apparatus using a power connector to receive power from the air conditioner through a power inlet.

15. The method of claim 11, further comprising a step of sending wireless alert signals to a user device using a wireless transmitter when the alarm circuit is activated.

16. The method of claim 15, wherein the wireless alert signals are transmitted via Bluetooth or Wi-Fi signals.

17. A filter monitoring system, comprising:
a two-part housing configured to be installed on a filter, the housing comprising an anterior module and a posterior module that magnetically attach to each other with the filter positioned between them;
a laser emitter positioned in the anterior module and oriented to direct a laser beam through the filter;
a photodetector positioned in the posterior module to detect the laser beam when the filter is unobstructed;
an alarm system comprising at least one of an acoustic alarm and an alert indicator;
a wireless transmitter configured to send alert signals to a user device; and
a control circuit that activates the alarm system and the wireless transmitter when the photodetector indicates that the laser beam is blocked by dust accumulation on the filter.

18. The filter monitoring system of claim 17, wherein the filter is an air conditioner filter.

19. The filter monitoring system of claim 17, wherein the anterior module comprises anterior magnets, and the posterior module comprises posterior magnets configured to magnetically couple with the anterior magnets.

20. The filter monitoring system of claim 19, wherein the two-part housing is made of plastic material and has a shape selected from the group consisting of cylindrical, square, triangular, rectangular, parallelogram, and spherical shapes.

21. The filter monitoring system of claim 17, further comprising a power source operatively connected to the control circuit, wherein the power source comprises at least one of a battery and a power connector configured to receive power from an air conditioner through a power inlet.

22. The filter monitoring system of claim 21, wherein the wireless transmitter is configured to communicate with the user device via Bluetooth or Wi-Fi signals.
